(19) United States
(12) Patent Application Publication
(10) Pub. No.: US 2009/0100527 A1
(43) Pub. Date: Apr. 16, 2009

(54) Real-time enterprise data masking

(76) Inventors: Adrian Michael Booth, Fremont, CA (US); Manmeet Singh Bhasin, Fremont, CA (US)

Correspondence Address: LESTER H. BIRNBAUM, 6 OAKMOUNT COURT, SIMPSONVILLE, SC, 29681, US

(21) Appl. No.: 12/287,324

(22) Filed: Oct. 8, 2008

Related U.S. Application Data
(60) Provisional application No. 60/998,421, filed on Oct. 10, 2007.

(51) Int. Cl. G06F 21/24

(52) U.S. Cl. 726/27

(57) ABSTRACT

The invention describes a method, a system and a computer program product for masking data in a database system. The database system includes a database in which sensitive data is stored. The database system also includes a Database Management System (DBMS) which manages the database. Further, the database system includes a plurality of users that run various database queries and commands on the sensitive data. Masking policies are set for users that have access to the sensitive data. Users without privileges to view or manipulate sensitive data may run their queries and commands on masked data, while users with privileges to run and manipulate sensitive data may run their queries and commands on sensitive data. The masked data is generated in real-time and is not stored on the database, thereby preserving its integrity.

### CROSS REFERENCE TO RELATED APPLICATION

This application claims the benefit of Provisional Application Ser. No. 60/998,421 filed Oct. 10, 2007.

### FIELD OF THE INVENTION

The present invention relates to a method, a system and a computer program product for masking data in a Database Management System (DBMS). In particular, the invention pertains to masking data based on policies defined for a user.

### BACKGROUND

Today, many medical, banking and insurance companies maintain databases with sensitive data such as social security numbers and credit card numbers. Many data security compliances, such as Payment Card Industry Data Security Standard (PCI DSS 1.1) and Health Insurance Portability and Accountability Act (HIPAA), are to be implemented by companies to ensure that sensitive data is protected at all times. This requires that sensitive data is protected in all databases.

One of the existing methods for protecting sensitive data is by providing random test data, instead of sensitive data, to software developers, testers and other users without access rights. This random test data is generated based on rules such as the type, length and range of data and may be used to test software applications for various test case scenarios.

Another method for protecting sensitive data is masking sensitive data by using various algorithms, and storing the masked data in a database. The owner of the sensitive data defines access rights for users. Users without access rights are shown masked data, whereas those with access rights are shown sensitive data.

One or more of the above-mentioned methods for protecting sensitive data have one or more of the following limitations. One of the limitations of the existing methods is their inability to replicate all the real-world test cases in software testing. Another limitation of the existing methods is the risk of corrupting sensitive data by manipulations performed on the sensitive data during data masking.

Therefore, there is a need for a method, a system and a computer program product for protecting sensitive data that preserves the integrity of the sensitive data and can test software for all real-world scenarios.

### SUMMARY

To solve the problems mentioned above, the present invention implements data masking on a database in real-time. The masked data is generated in real-time based on the masking policies set by the owner of the sensitive data. In this way, the integrity of sensitive data is preserved and all real-world scenarios for the application of software can be tested, since the masked data generated from the sensitive data is realistic.

According to the present invention, the owner of the sensitive data sets masking policies for users with access rights to the data. Users running a query or command on sensitive data are provided with masked or sensitive data according to the masking policies defined for them.

According to another embodiment of the present invention, various triggers are set on the sensitive data. These triggers are fired when a user runs a query or command on the sensitive data. The triggers initiate procedures that are stored in the database. The procedures check the masking policies associated with the user and provide the user with masked or sensitive data based on the masking policies. These procedures generate the masked data in real-time.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 illustrates a database system, according to an embodiment of the present invention;

FIG. 2 illustrates a real-time masking system, according to an embodiment of the present invention;

FIG. 3 illustrates a database system, according to yet another embodiment of the present invention;

FIG. 4 illustrates a database system, according to yet another embodiment of the present invention;

FIG. 5 illustrates a real-time masking system, according to another embodiment of the present invention;

FIG. 6 illustrates a flowchart for performing a method for data masking in a database, according to an embodiment of the present invention;

FIG. 7 illustrates a flowchart for performing a method for generating masking policies, according to an embodiment of the invention;

FIG. 8 illustrates a flowchart for performing a method for integrating the masking policies in data in a database, according to an embodiment of the invention; and

FIGS. 9a and 9b illustrate a flowchart for performing a method for generating masking policies and integrating the masking policies in data, according to an embodiment of the invention.

### DETAILED DESCRIPTION OF THE INVENTION

While various embodiments of the present invention have been illustrated and described, it will be clear that the present invention is not limited to these embodiments only. Numerous modifications, changes, variations, substitutions and equivalents will be apparent to those skilled in the art without departing from the spirit and scope of the present invention.

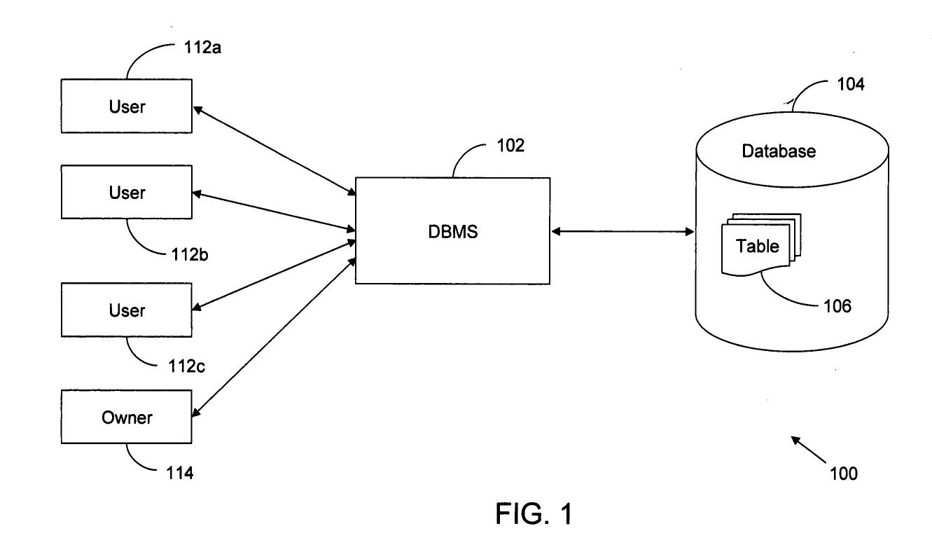

FIG. 1 illustrates a database system 100, according to an embodiment of the present invention. Database system 100 includes a database 104, which stores the data in a structured format. Database 104 also includes a table 106, which stores data in a tabular format. Database system 100 includes a Database Management System (DBMS) 102, which manages database 104. Examples of DBMS include, but are not limited to, Oracle, DB2, Microsoft Access, Microsoft SQL Server, PostgreSQL, MySQL, FileMaker, Sybase Adaptive Server Enterprise, and the like. Further, database system 100 includes users 112a, 112b and 112c that connect to DBMS 102 and send various database queries or commands to DBMS 102. Examples of database commands include, but are not limited to, INSERT, DELETE, UPDATE, and the like. A user may be a human user or a software application. In an embodiment of the present invention, users 112a, 112b and 112c may be given rights to create tables such as table 106. Database system 100 also includes an owner 114. Owner 114 may create a table such as table 106 in database 104. Owner 114 may give access rights to users 112a, 112b and 112c to run various database queries or commands on table 106. According to an embodiment of the invention, owner 114 may also be a user.

In an example of the present invention, owner 114 is the owner of table 106 and provides user 112a with access rights to select the first two columns in table 106 and user 112b with access rights to select, insert and update all the columns in table 106. Based on these policies, user 112a may select data in the first two columns of table 106, but cannot update data or create new rows in it.

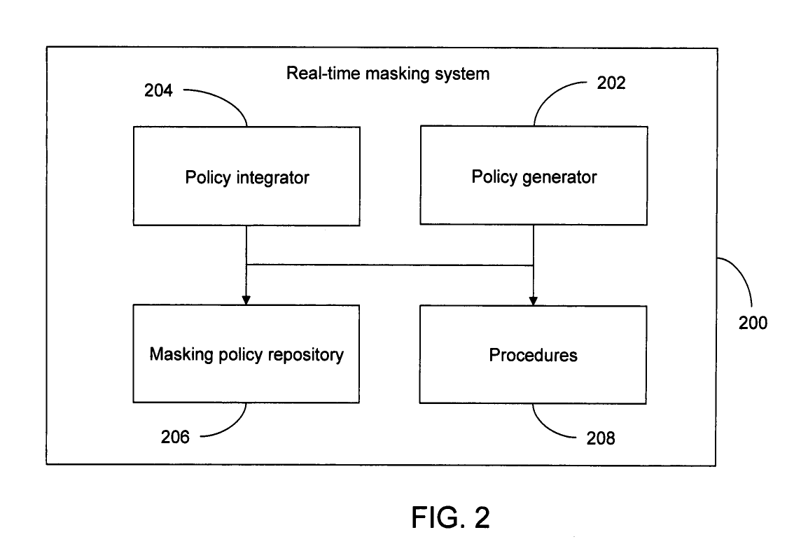

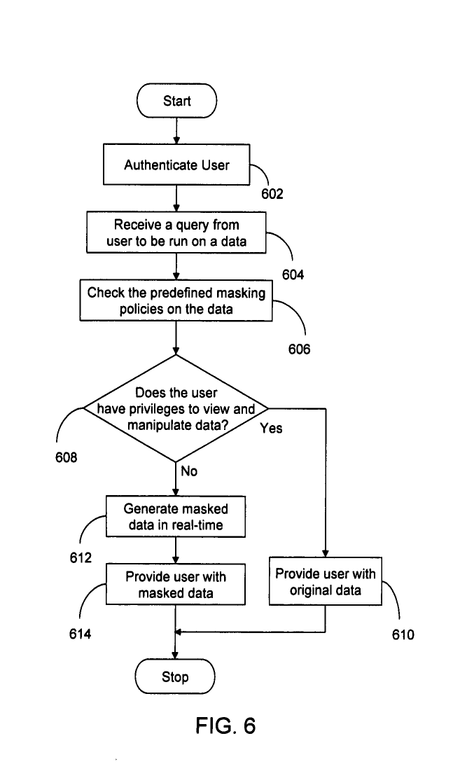

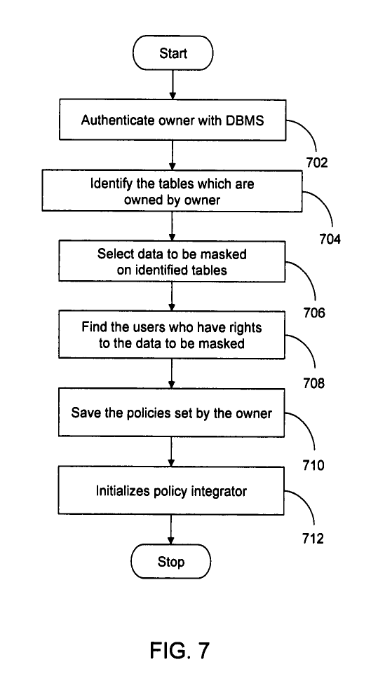

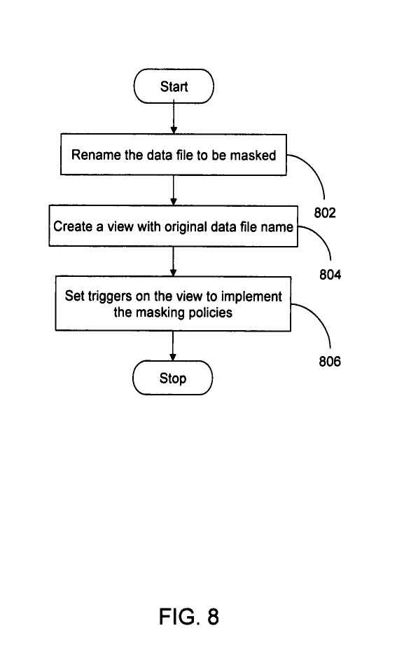

FIG. 2 illustrates a real-time masking system 200, according to an embodiment of the present invention. According to various embodiments of the present invention, system elements of real-time masking system 200 can be implemented in DBMS 102, database 104, table 106 or any other data processing system connected to DBMS 102. Real-time masking system 200 includes a policy generator 202. Policy generator 202 authenticates a user with DBMS 102. Policy generator 202 is used by an owner, similar or identical to owner 114, to retrieve a list of all the users who have access rights to the data to be masked from the DBMS. Further, policy generator 202 generates masking policies based on data to be masked, the viewing and manipulation privileges of users, and masking algorithms assigned to the users. According to an embodiment of the present invention, the policy generator generates the masking policies for the selected users based on a table or column to be masked, viewing and manipulation privileges of users, masking algorithm assigned to the selected user and various parameters for masking algorithms. An example of a parameter would be the maximum and minimum percentage in a percentage masking algorithm. Furthermore, policy generator 202 saves the masking policies in a masking policy repository 206, which stores the masking policies of users. According to an embodiment of the present invention, masking policy repository 206 can be a table stored in the database that is similar to database 104. The table includes various parameters such as a table or column to be masked, viewing and manipulation privileges of users, a masking algorithm assigned to the selected user, and various parameters for masking algorithms. Real-time masking system 200 also includes a policy integrator 204 that sets triggers on data in a database that is similar to database 104. Moreover, real-time masking system 200 includes procedures 208, which are run when the triggers are fired. Procedures 208 generate masked data in real-time, based on the masking policies. The triggers are fired when a user runs various database queries and commands on the data. Various functions of the system elements defined can be understood in conjunction with flow charts in FIG. 6, FIG. 7, and FIG. 8.

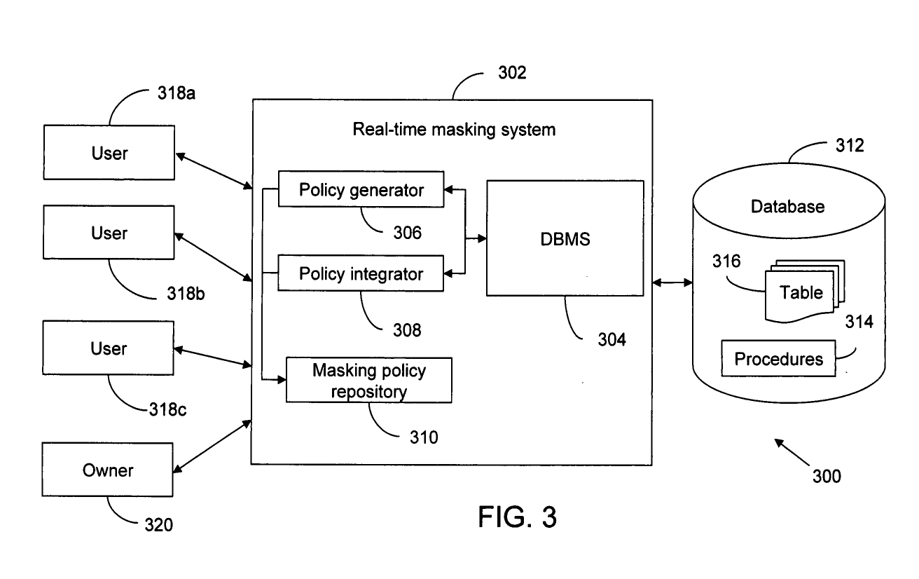

FIG. 3 illustrates a database system 300, according to another embodiment of the invention. Database system 300 includes a real-time masking system 302. Real-time masking system 302 includes a DBMS 304 that is similar or identical to DBMS 102, a policy generator 306 that is similar or identical to policy generator 202, a policy integrator 308 that is similar or identical to policy integrator 204, a masking policy repository 310 that is similar or identical to masking policy repository 206, and a table 316 that is similar or identical to table 106. Database system 300 also includes users 318a, 318b and user 318c that are similar or identical to user 112. Further, database system 300 includes a database 312 that is similar or identical to database 104. Procedures 314 that are similar or identical to procedures 208 are stored in database 312. Various functions of the system elements defined can be understood in conjunction with flow charts in FIG. 6, FIG. 7, and FIG. 8.

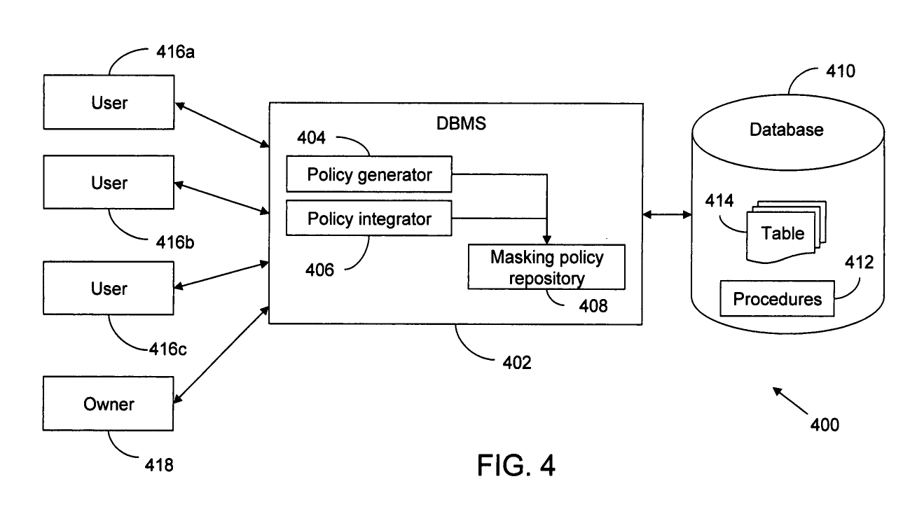

FIG. 4 illustrates a database system 400, according to another embodiment of the invention. Database system 400 includes a DBMS 402 that is similar or identical to DBMS 102. DBMS 402 includes a policy generator 404 that is similar or identical to policy generator 202, a policy integrator 406 that is similar or identical to policy integrator 204, a masking policy repository 408 that is similar or identical to masking policy repository 206, and a table 414 that is similar or identical to table 106. Database system 400 also includes users 416a and 416b and user 416c that are similar or identical to user 112. Database system 400 further includes a database 410 that is similar or identical to database 104. DBMS 402 may mask data in real-time. Procedures 412 that are similar or identical to procedures 208 are stored in database 410. Various functions of the system elements defined can be understood in conjunction with flow charts in FIG. 6, FIG. 7, and FIG. 8.

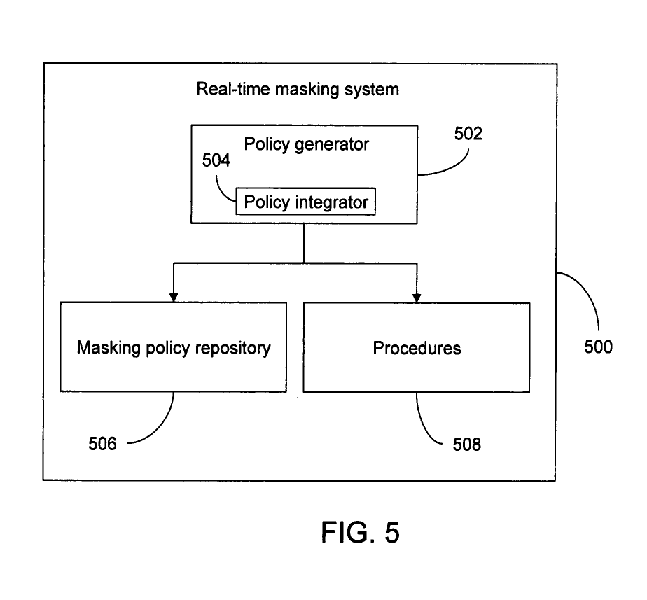

FIG. 5 illustrates a real-time masking system 500, according to another embodiment of the present invention. Real-time masking system 500 includes a policy generator 502 that is similar or identical to policy generator 202. Real-time masking system 500 also includes a masking policy repository 506 that is similar or identical to masking-policy repository 206. Policy generator 502 includes a policy integrator 504 that is similar or identical to policy integrator 204. System 500 further includes procedures 508 that are similar or identical to procedures 208. Various functions of the system elements defined can be understood in conjunction with flow charts in FIG. 6, FIG. 7, and FIG. 8.

FIG. 6 illustrates a flowchart for performing a method for data masking in a database, according to an embodiment of the present invention. The database may be similar or identical to database 104. A user that is similar to users 112a, 112b or 112c sends a query to a DBMS such as DBMS 102. The query is run on data in a database that is similar or identical to database 104. The data may be stored in one or more tables such as table 106. The owner of the data that is similar to owner 114 defines the masking policies for a user. These masking policies are in addition to the access rights that may also be set by the owner. At step 602, the user connects and authenticates to the DBMS. In an embodiment of the present invention, the user may be using a client-server or web-based application, and the like, to connect to the DBMS. After the authentication, the DBMS may authorize the user to access the data in the database based on the access rights of the data. At step 604, the DBMS receives a query from the user that is to be run on the table. At step 606, the predefined masking policies of the data corresponding to the user are checked. At step 608, it is determined if the user has privileges to view and manipulate data according to the predefined masking policies, and if so, step 610 is executed, otherwise step 612 is executed. At step 610, data is provided to the user without masking. At step 612, the masked data is generated in real-time based on the predefined masking policies, and is not stored in the database. The data may be masked by using algorithms including, but not limited to, scrambling, incrementing and decrementing values, shuffling data, increasing and decreasing by percentage, date aging, reordering data within a field or using a special character in a defined location. At step 614, the masked data is provided to the user.

According to an example of the present invention, user 112b is a software developer who need access rights to run a query on table 106. Table 106 may contain sensitive data that can compromise the security of a company. The owner of table 106 may set up masking policies to mask data provided to user 112b. These masking policies contain information about the users for whom the masking is to be implemented and the masking algorithm used.

FIG. 7 illustrates a flowchart for performing a method for generating masking policies, according to an embodiment of the invention. The database may be similar to database 104. An owner that is similar to owner 114 is connected to a policy generator that is similar or identical to policy generator 202. At step 702, the policy generator authenticates the owner with a DBMS that is similar or identical to DBMS 102. At step 704, the policy generator identifies tables in the database owned by the owner. At step 706, the owner selects columns or rows to be masked on one or more of the identified tables. At step 708, the policy generator retrieves a list of all the users who have access rights to the data to be masked from the DBMS. The owner then selects users for whom data masking may be performed, and assigns a masking algorithm that is to be used for each selected user. In an embodiment of the present invention, the policy generator generates the masking policies based on data to be masked, the viewing and manipulation privileges of selected users, and the masking algorithm assigned to the selected users. According to another embodiment of the present invention, the policy generator generates the masking policies for the selected users based on the table or column selected for masking, selected users, masking algorithm assigned to the selected user, and various parameters for masking algorithms. At step 710, the policy generator saves the masking policies in a masking policy repository that is similar or identical to masking policy repository 206. At step 712, the policy generator initializes a policy integrator that is similar or identical to policy integrator 204.

FIG. 8 illustrates a flowchart for performing a method for integrating the masking policies on data in a database, according to an embodiment of the invention. The database is similar or identical to database 104. At step 802, a policy integrator that is similar or identical to policy integrator 204 renames a table to be masked. In an embodiment of the present invention, the table is similar or identical to table 106. At step 804, the policy integrator creates a view of the table with the original name of the table. A user accessing table 106 thereby accesses the view instead of the table. In this way data in table 106 is protected from the user. The view derives its data from the tables and/or views on which it is based. According to an embodiment of the present invention, the view may be a presentation of data that is selected from one or more tables. In another embodiment of the present invention, the view may also present data from other views. At step 806, the policy integrator sets triggers on the view. These triggers are fired when database queries or commands including, but not limited to, INSERT, DELETE, UPDATE or SELECT are run by a user on the view. The trigger initiates a procedure that is similar to procedure 208. In an embodiment of the present invention, a procedure may include SQL and PL/SQL or Java statements. The procedure checks the masking policies of the user and provides masked or unmasked data based on the masking policies. The procedures generate masked data in real-time according to the algorithms set for the user.

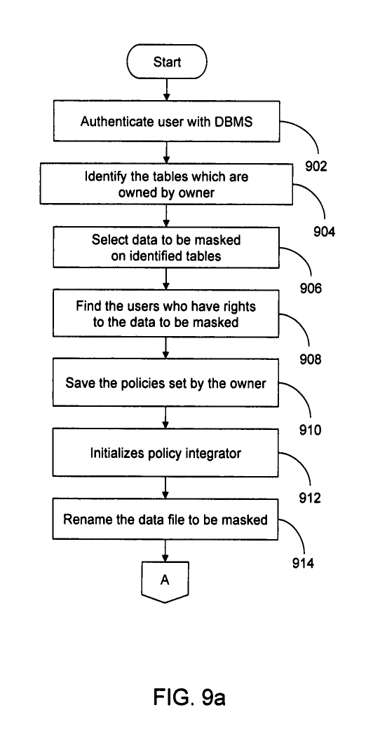

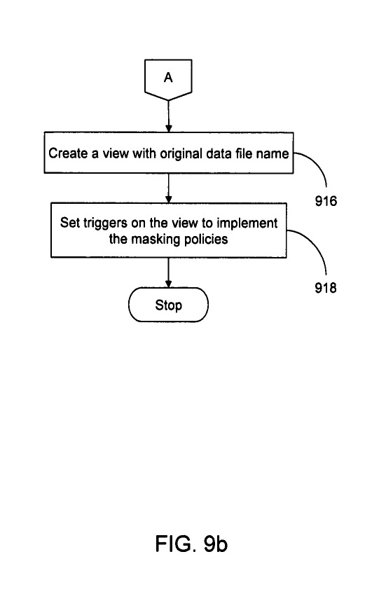

FIG. 9a and FIG. 9b illustrate a flowchart for performing a method for generating masking policies and integrating the masking policies on data, according to an embodiment of the invention. The database may be similar or identical to database 104. An owner that is similar to owner 114 is connected to a policy generator that is similar or identical to policy generator 502. At step 902, the policy generator authenticates the owner with a DBMS that is similar or identical to DBMS 102. At step 904, the policy generator identifies tables in the database owned by the owner. At step 906, the owner selects the columns or rows to be masked on one or more of the identified tables. At step 908, the policy generator retrieves a list of all the users that have access rights to the data to be masked from the DBMS. The owner then selects users for whom data masking may be performed, and assigns a masking algorithm that is to be used for each of the selected users. In an embodiment of the present invention, the policy generator generates masking policies for the selected users based on their viewing and manipulation privileges and the masking algorithm assigned to them. At step 910, the policy generator saves the policies in a masking policy repository that is similar or identical to masking policy repository 206. At step 912, the policy generator initializes a policy integrator that is similar or identical to policy integrator 504. At steps 914 and 916, the policy integrator renames a table to be masked, such as table 106, and creates a view of the table with the original name of the table. A user accessing table 106, thereby accesses the view instead of the table. In this way data in table 106 is protected from the user. At step 918, the policy integrator sets triggers on the view. These triggers are fired when database queries or commands including, but not limited to, INSERT, DELETE, UPDATE or SELECT are run by a user on the view. The trigger initiates a procedure that is similar or identical to procedure 208. In an embodiment of the present invention, a procedure may include SQL and PL/SQL or Java statements. The procedure checks the masking policies of the user and provides masked or unmasked data based on the masking policies. The procedures generate masked data in real-time according to the algorithms set for the user.

The method and system for masking data, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system typically comprises a computer, an input device, and a display unit. The computer typically comprises a microprocessor, which is connected to a communication bus. The computer also includes a memory, which may include random access memory (RAM) and read only memory (ROM). Further, the computer system comprises a storage device, which can be a hard disk drive or a removable storage drive such as a floppy disk drive, an optical disk drive, and the like. The storage device can also be other similar means for loading computer programs or other instructions on the computer system.

The computer system executes a set of instructions that are stored in one or more storage elements to process input data. The storage elements may also hold data or other information, as desired, and may be an information source or physical memory element present in the processing machine.

The set of instructions may include various commands that instruct the processing machine to execute specific tasks such as the steps constituting the method of the present invention. The set of instructions may be in the form of a software program. The software may be in various forms such as system software or application software. Further, the software might be in the form of a collection of separate programs, a program module with a larger program, or a portion of a program module. The software might also include modular programming in the form of object-oriented programming. Processing of input data by the processing machine may be in response to user commands, to the results of previous processing, or to a request made by another processing machine.

While various embodiments of the invention have been illustrated and described, it will be clear that the invention is not limited to these embodiments only. Numerous modifications, changes, variations, substitutions and equivalents will be apparent to those skilled in the art without departing from the spirit and scope of the invention.

What is claimed is:

1. A method for masking data in a database system, the method comprising:
a. receiving a query from a user;
b. subsequently generating masked data in real-time based on predefined masking policies; and
c. providing the masked data to the user.

2. The method according to claim 1, further comprising providing unmasked data to the user based on predefined masking policies.

3. The method according to claim 1, further comprising defining the predefined masking policies by an owner of the data, wherein the masking policies are in addition to access rights.

4. The method according to claim 1, wherein the masking policies comprise defining user privileges to the data on the database.

5. The method according to claim 1, wherein the database system is one of Oracle, DB2, Microsoft Access, Microsoft SQL Server, PostgreSQL, MySQL, FileMaker, Sybase Adaptive Server Enterprise.

6. The method according to claim 1, wherein the user is a human user.

7. The method according to claim 1, wherein the user is a software application.

8. The method according to claim 1, wherein the query is a database command selected from the group consisting of INSERT, DELETE, UPDATE and SELECT.

9. The method according to claim 1, further comprising masking data using one or more algorithms selected from the group consisting of scrambling, incrementing & decrementing values, shuffling data, increasing & decreasing by percentage, date aging, reordering data within a field, and using a special character in a defined location.

10. A data masking system in a database system, the database system comprising a database and a Database Management System (DBMS), the data masking system comprising:
a. a policy generator for generating masking policies for data, wherein an owner of the data defines the masking policies; and
b. a policy integrator for applying masking policies on the data;
wherein the data is masked in real time when a user accesses the data based on the masking policies.

11. The system according to the claim 10, wherein the data masking system further comprises:
a. a masking policy repository for storing the masking policies; and
b. procedures for generating masked data based on the defined masking polices.

12. The system according to claim 11, wherein the policy generator stores the generated masking policies in the masking policy repository.

13. A computer readable medium storing instructions that, when executed by a computing device, cause the computer to perform a method of masking data in a database system, the method comprising:
a. receiving a query from a user;
b. subsequently generating masked data in real-time based on predefined masking policies; and
c. providing the masked data to the user.
